(19) United States
(12) Patent Application Publication
(10) Pub. No.: US 2005/0270674 A1
(43) Pub. Date: Dec. 8, 2005

(54) Ground rubber attached to substrate for contact magnetic printing

(76) Inventors: Koichi Wago, Sunnyvale, CA (US); Gennady Gauzner, Livermore, CA (US)

Correspondence Address: Raghunath S. Minisandram;Seagate Technology LLC, 920 Disc Drive, SV15B1, Scotts Valley, CA, 95067, US

(21) Appl. No.: 10/860,817

(22) Filed: Jun. 4, 2004

(51) Int. Cl. G11B 5/86

(52) U.S. Cl. 360/17

(57) ABSTRACT

An elastomer pad used in a system and method for servo formatting magnetic media using contact magnetic printing is disclosed. The elastomer pad includes a substrate substantially the same shape and size as the magnetic media and an elastomer material bonded to the substrate wherein the substrate provides support for the elastomer material. Further an apparatus for creating magnetic patterns on magnetic media, including the elastomer pad, is disclosed and includes a stamper having a pattern, a press for supplying a force to the stamper and the magnetic media, the elastomer pad including the substrate and bonded elastomer material, positioned between the stamper and the press for enabling the stamper to conform to the contours of the unflat stamper, and a magnet for supplying a magnetic field to the stamper and the magnetic media causing the pattern on the stamper to be transferred to the magnetic media.

### BACKGROUND OF THE INVENTION

1. Field of the Invention

The present invention relates generally to the field of disc drive storage, and more particularly to contact magnetic printing used to create magnetic patterns on magnetic recording media.

2. Description of the Related Art

Conventional disc drives use magnetic properties of materials to store and retrieve data. Typically, disc drives are incorporated into electronic equipment, such as computer systems and home entertainment equipment, to store large amounts of data in a form that can be quickly and reliably retrieved. The major components of a disc drive include magnetic media in the form of a disk, read-write heads, a motor and software. The magnetic media is rotated by a motor at a constant high speed while the read-write head, which rests on a head gimble assembly, glides over the magnetic media reading and writing signals to the media. The surface of each magnetic media is divided into a series of data tracks, which are radially spaced apart and which extend circumferentially around the magnetic media disc. The data tracks store data in the form of magnetic flux transitions within the radial extent of the tracks on the disc surfaces.

Typically, each data track is divided into a number of data sectors that store fixed sized blocks of user data. Embedded among the sectors on each track are servo fields that enable the disc drive to control the position of heads used to transfer the user data between the discs and a host computer. More particularly, the heads are mounted to a rotary actuator assembly which includes a coil of a voice coil motor, so that the position of the heads relative to the tracks can be maintained by the application of current to the coil by a closed loop digital servo system in response to the servo information read by the servo fields.

The servo fields have traditionally been written onto discs during the manufacture of the disc drives using an extremely precise servo track writer. Typically this process of writing servo tracks is done at the drive assembly facility, before the disc is assembled into a drive, and after the disc has been manufactured and shipped to that facility. Conventional servo track writers typically write servo fields to disks by rotating an individual disk and precisely moving a head to a specific position on the disk and magnetically recording a signal on a precise location of the disc. Some problems associated with conventional servo track writers are that they are slow and are normally done at the drive assembly location.

In order to overcome these problems a significant amount of work has been done to develop alternative servo writing techniques including using contact magnetic printing techniques for writing servo patterns on magnetic media. Contact magnetic printing techniques and their application to the disk drive industry are described in U.S. patent application Ser. No. 10/262,300 titled “SYSTEM AND METHOD FOR CONTACT MAGNETIC PRINTING,” which is incorporated by reference. Although, some work has been done in the area of conventional contact magnetic printing there are still some problems associated with the technique.

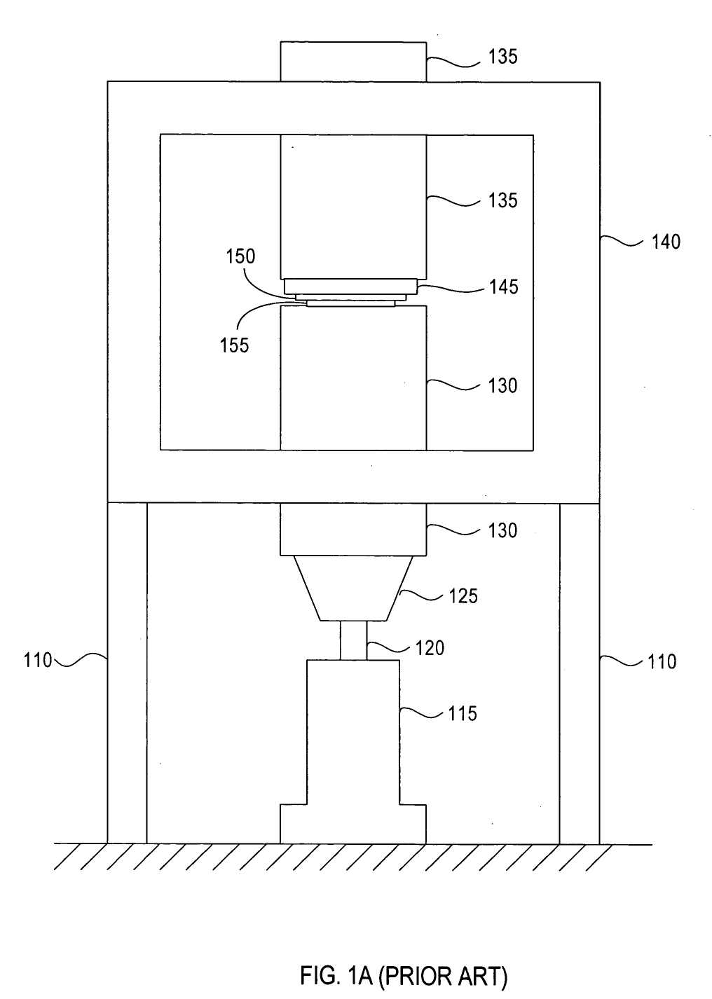

FIG. 1A is a block diagram showing an apparatus used for contact magnetic printing, which typically includes a frame 110, a press 115, a driving rod 120, a stage 125, a first magnetic pole 130, a second magnetic pole 135, a yoke 140, an elastomer pad 145, a stamper 150, and a magnetic media 155. The frame 110, driving rod 120 and stage 125 are used to compress the elastomer pad 145, magnetic media 155, first magnetic pole 130 and second magnetic pole 135 together so that magnetic printing can be optimized. The first magnetic pole 130, the second magnetic pole 135 and the yoke 140 make up the dipole magnet that supplies a magnetic field to the elastomer pad 145, the stamper 150, and the magnetic media 155. The press 115 is used for pressing the stamper 150 firmly against the magnetic media 155, while the magnetic media 155, the elastomer pad 145, and the stamper 150 are exposed to a magnetic field generated by the first magnetic pole 130 and the second magnetic pole 135. The elastomer pad 145 is used to deliver, and spread evenly, the force of the press 115 on the magnetic media 155 and stamper 150 stack.

Contact magnetic printing of servo patterns on magnetic media is done by first positioning the magnetic media 155 against the stamper 150 so that the stamper 150 is abutted against the magnetic media 155. The magnetic media 155 and stamper 150 stack is then loaded and aligned in the system for contact magnetic printing described above with reference to FIG. 1A, applying a force on the magnetic media 155 and stamper 150 stack so that they are in firm contact with each other at the interface. A sequence of magnetic fields, of sufficient strength, is then applied for a set time to the magnetic media/stamper stack while it is subjected to the force. An example of a typical sequence of magnetic fields includes applying a first magnetic field of approximately 15KOe in one direction for a few milliseconds and then applying a second field of approximately 3KOe is the opposite direction for a few milliseconds. Finally, the magnetic field is removed, the magnetic media/stamper stack is unloaded from the contact magnetic printing apparatus and the stamper 150 and magnetic media 155 are separated.

In order to facilitate reliable operation of the disc drive, proper radial alignment of the servo fields is essential. If errors are introduced in the placement of the servo fields, position error signals (PES) generated by the servo system during subsequent operation of the drive are detected at corresponding frequencies. The PES is a measure of the relative position of a selected head with respect to an associated track and is used primarily during track following operations to maintain the head over the center of the track. Frequency dependent PES for a given track result in the repeated adjustment of the position of the head by the servo system in an attempt to maintain the head over the center of the track during each revolution of the disc. When such frequencies are sufficiently severe, the correction required to account for these frequencies can require a significant amount of correction limiting the overall track density that can be achieved in a disc drive design. One source of error that occurs during the servo writer process is the spindle motor, which includes bearing assemblies with characteristic frequencies that are generated from the rotation of the balls and ball cages within the inner and outer bearing raceways. These bearing frequencies can result in low frequency errors being laid down in the servo pattern.

Another source of errors that can cause incorrect servo track patterns is misalignment of the stamper and the magnetic media at the time the magnetic field is applied. When doing magnetic contact printing, as well as imprint lithography, it is preferable to have direct contact between the stamper 150 and the magnetic media 155 over a large area. In order to compensate for the unflatness of magnetic media 155 or the stamper 150, the elastomer pad 145 is placed on the back of the stamper 150 to make the stamper conform to the magnetic media surface as is further discussed with reference to FIGS. 1B-1E below. Additionally, the elastomer pad 145 is used to cushion the different components so that they are not distorted or damaged during the pressing process.

FIG. 1B is an exploded view illustrating a stamper 150 conforming to the contours or unflatness of the magnetic media when a force is applied to it indirectly through an elastomer pad 145. Although the elastomer pad 145 solves the problem of unflatness throughout the magnetic media 155, the conventional elastomer pad creates other problems near the outer diameter of the magnetic media as illustrated in FIGS. 1D-1E below.

FIG. 1C is an exploded view of FIG. 1A illustrating the first magnetic pole 130, the second magnetic pole 135, the elastomer pad 145, the stamper 150, and the magnetic media 155 before a force is applied to the stamper and magnetic media during the stamping process.

FIGS. 1D-1E illustrate the problems with deformation of the stamper 150 or deformation of conventional elastomer pads 145 when a force is applied to the stamper 150 and magnetic media 155 stack during the contact magnetic printing process. Both FIG. 1D and FIG. 1E show the elastomer pad 145, the stamper 150, and the magnetic media 155 being subjected to an applied force that is transferred through the first magnetic pole 130, second magnetic pole 135. FIG. 1D shows the possible distortion of the stamper 150 when a force is applied to it whereas FIG. 1E show the possible distortion of elastomer pad 145 when a force is applied to it. Both of these distortions result in an inaccurate servo pattern being written on the outer diameter region of the magnetic disc.

Accordingly, there is a need for a contact magnetic printing system and method that permits the writing of servo patterns without distortion of the elastomer pad so that clear patterns can be written through the magnetic media including near the outside diameter of the magnetic media reducing the number of servo data errors written to discs of a disc drive.

### SUMMARY OF THE INVENTION

These problems with the elastomer pad are overcome by using an elastomer pad made out of an elastomer material bonded to a substrate that is made out of a sturdy material. This configuration has the advantage of delivering uniform pressure to an unflat surface of an object without having deformation of the elastomer material, at the edges, that is so significant that the pressure on the edges of the unflat object changes.

In one embodiment the substrate is substantially the same size and shape as the unflat surface. When applying this embodiment to the contact magnetic printing process used to print servo patterns on magnetic media both the substrate with bonded elastomer pad and the unflat object are disc shaped or disc shaped with an inside diameter and an outside diameter. One-way of achieving a substrate that is substantially the same size and shape as the unflat surface is to use the same substrate as used for the unflat surface. For example in contact magnetic printing this can be a conventional Aluminum substrate with a Nickel Phosphorous coating.

The elastomer material should be a rubber-like material that is hard enough for a specific application. For example in contact magnetic printing the elastomer material should have a Durometer Shore hardness ranging from 30 to 70 shore and preferably near 50 shore. Although the preferred elastomer material is Silicone, the elastomer material can be made from other elastomer materials including but not limited to Nitrile, Carboxylated Nitrile, Polyacrylate, Ethylene Propylene, Neoprene, Silicone, Vamac, Hydrogenated Nitrile, and Viton.

The elastomer material can be bonded to the substrate using a variety of methods. The preferred method of bonding the elastomer material to the substrate involves heating granulars of the elastomer material that have been put into a mold covering the substrate so that the elastomer melts and bonds to the substrate. After the elastomer cools and solidifies it is grinded down to a predetermined thickness.

Finally the elastomer pad can be used in conjunction with a system for creating magnetic patterns on magnetic media, comprising a stamper having a pattern, a press for supplying a force to the stamper and the magnetic media the an elastomer pad positioned between the stamper and the press for enabling the stamper to conform to the contours of the unflat stamper and a magnet for supplying a magnetic field to the stamper and the magnetic media causing the pattern on the stamper to be transferred to the magnetic media. The system can be used to write servo patterns on magnetic media by first positioning and aligning the magnetic media against the stamper. Next, the magnetic media and stamper stack is loaded and aligned in a system for contact magnetic printing. A force on the magnetic media and stamper stack is then applied so that they are in firm contact with each other at the interface. A sequence of magnetic fields, of sufficient strength, is then applied for a set time to the magnetic media and stamper stack while it is subjected to the force. An example of a typical sequence of magnetic fields includes applying a first magnetic field of approximately 15KOe in one direction for a few milliseconds and then applying a second field of approximately 3KOe is the opposite direction for a few milliseconds. Finally, the magnetic field is removed, the magnetic media and stamper stack is unloaded from the contact magnetic printing apparatus and the stamper and magnetic media are separated.

### BRIEF DESCRIPTION OF THE INVENTION

FIG. 1A is a block diagram showing a contact magnetic printer using actuated magnet poles for contact pressure source in accordance with an embodiment of the invention.

FIG. 1B is an illustration showing a stamper conforming to the typical unflat contours of a magnetic disc.

FIG. 1C is an illustration showing an exploded view of an elastomer pad, stamper, and magnetic media absent the application of an external force.

FIG. 1D is a cross-sectional view of FIG. 1C showing the deformation of the stamper while an external force is applied to the system.

FIG. 1E is a cross-sectional view of FIG. 1C showing the deformation of the conventional elastomer pad while an external force is applied to the system.

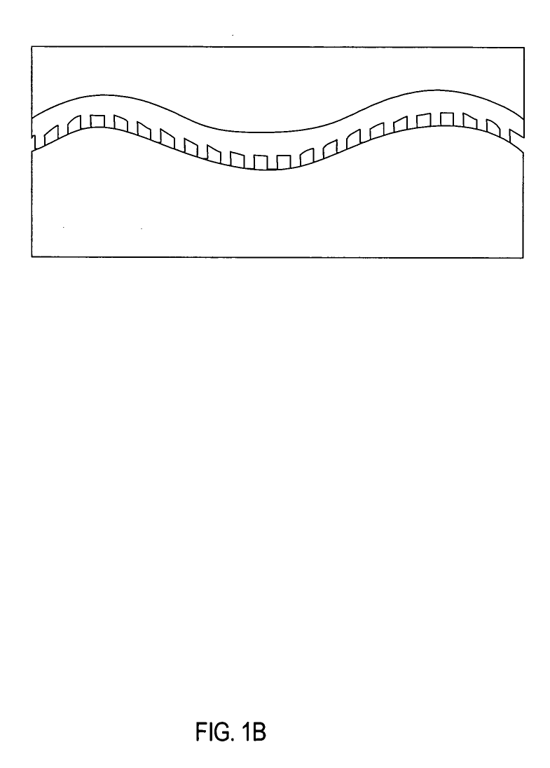

FIG. 2 is a block diagram showing a grounded-rubber-attached-to-substrate (GRAS) elastomer pad in accordance with one embodiment of the invention.

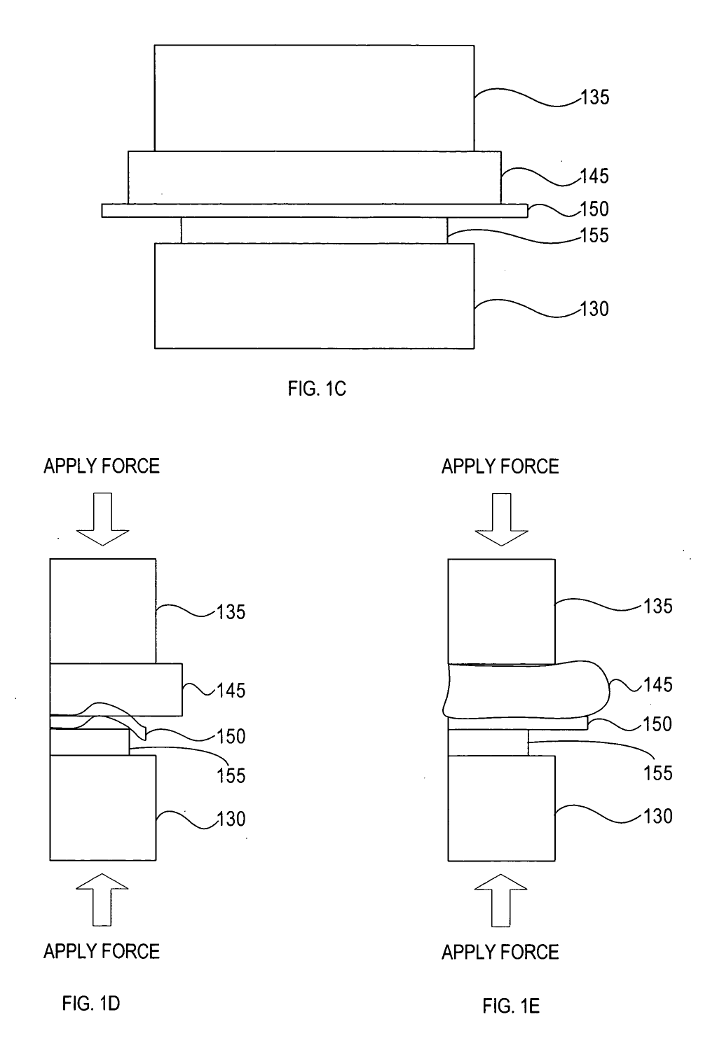

FIG. 3 is an illustration showing an exploded view of a GRAS elastomer pad, stamper, and magnetic media with an application of an external force in accordance with one embodiment of the invention.

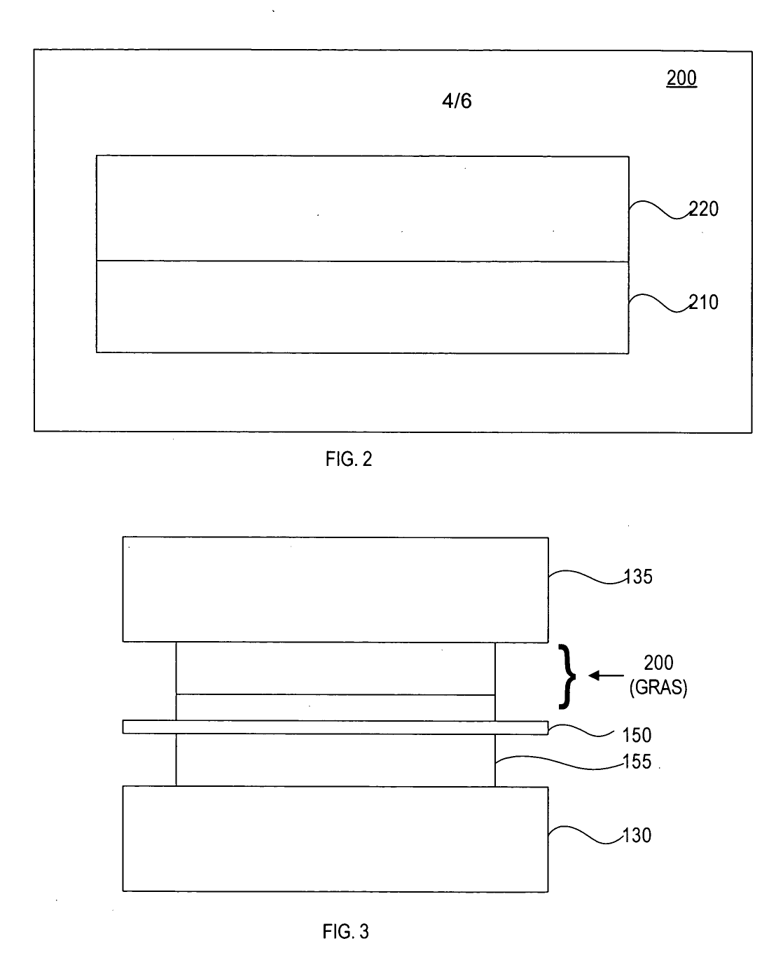

FIG. 4A and FIG. 4B are a side-by-side comparison of the pressure profile showing the pressure on a stamper and magnetic media when pressure is applied with a conventional elastomer pad and a GRAS elastomer pad, respectfully.

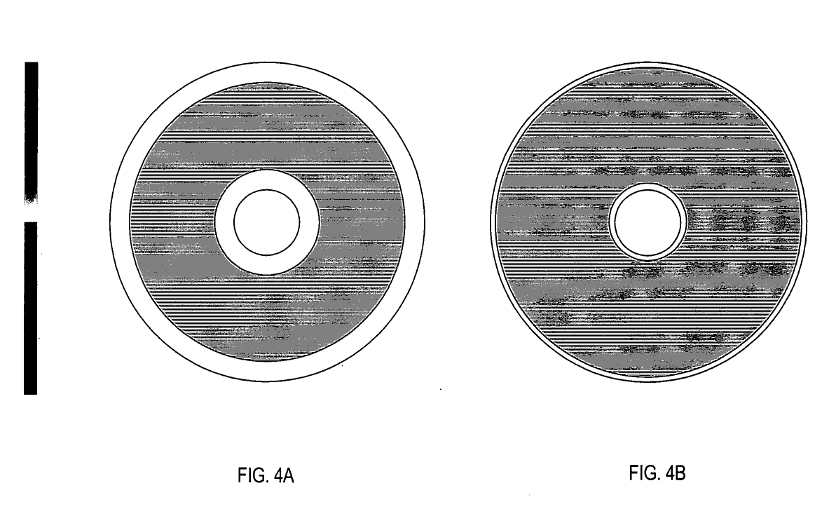

FIG. 5 is a graph showing replicated feature height with imprint lithography, when using a GRAS elastomer pad, as function of magnetic media radius.

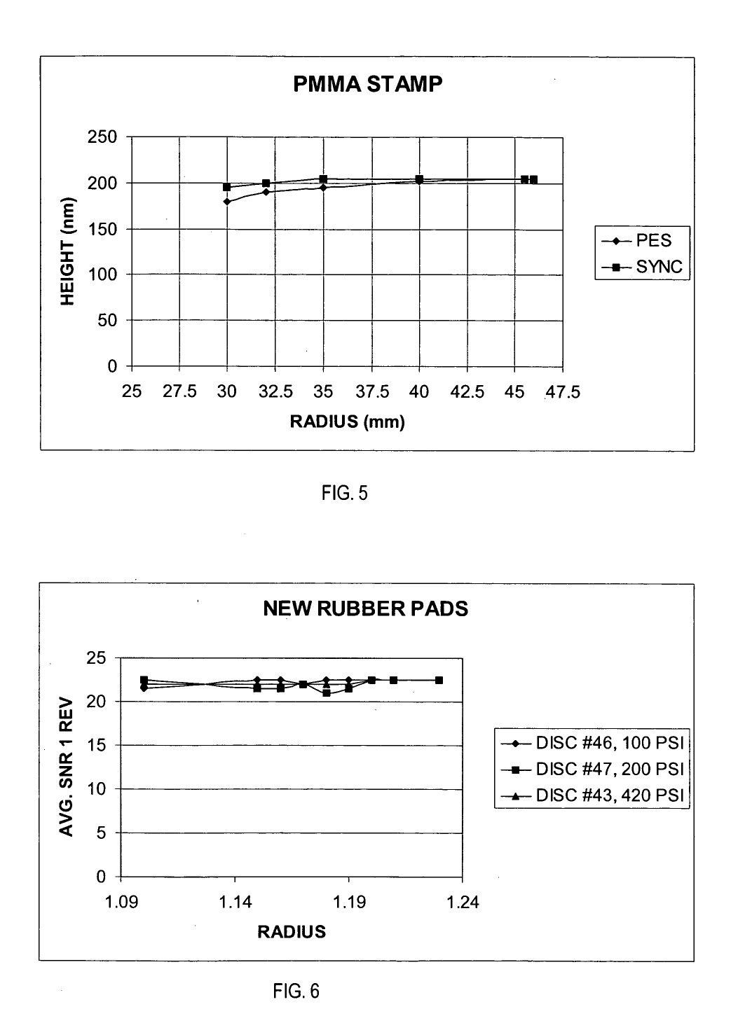

FIG. 6 is a graph showing magnetic contact printed signal to noise ratio (SNR), when using a GRAS elastomer pad for contact magnetic printing, as function of magnetic media radius.

### DETAILED DESCRIPTION OF THE PREFERRED EMBODIMENTS

The invention provides a system that overcomes the problems with conventional contact magnetic printing as discussed in the background of the invention section above. One embodiment of the invention allows creating magnetic patterns on magnetic media that are uniform from the inside diameter of a magnetic media to the outside diameter of the magnetic media. In particular, the invention provides a system for servo formatting magnetic media using contact magnetic printing that results in uniform servo writing.

FIG. 2 is a block diagram showing a grounded-rubber-attached-to-substrate (GRAS) elastomer pad 200 in accordance with one embodiment of the invention. The grounded-rubber-attached-to-substrate (GRAS) elastomer pad 200 includes a substrate 210 and an elastic material 220 that is bonded to the substrate 210. The substrate can be made of any material which is sturdy enough to withstand the application of a force needed. For example if the application requires a small force of several Newtons then the substrate 210 material can be less sturdy. If the application requires a large force then the substrate 210 should be made of a more sturdy material. For example, in contact magnetic printing used on magnetic media to write servo patterns the force applied can be large so a substrate 210 can be made out of a material such as an aluminum substrate with or without a Nickel Phosphorus (NiP) coating typically used for magnetic media. Additionally, the size of the substrate 210 should be the same as the size of the magnetic media 155 so that the when a force is applied to the stamper 150 and magnetic media 155 and the GRAS elastomer pad the force is delivered uniformly to the entire stamper 150 and magnetic media 155.

The elastic material 220 is made out of a material that can deform when a force is applied to it such as a polymer, elastomer or rubber-like substance. Some examples that elastomer material 220 can be made out of include Nitrile, Carboxylated Nitrile, Polyacrylate, Ethylene Propylene, Neoprene, Silicone, Vamac, Hydrogenated Nitrile, and Viton. One skilled in the art will realize that in addition many elastic materials can be used depending on the application and that this invention is not limited to any specific material. Some applications may require that the elastic material 220 should be at least clean-room compatible and preferably vacuum compatible whereas other applications may have no such requirements. In one embodiment, Silicone is preferred because it is easy to use and is compatible with many processes including those used in semiconductor grade clean rooms. The hardness of the elastomer is also selected to be within a range of 30-70 shore as measured by a Durometer Shore apparatus. The Durometer Shore is designed to measure the penetration hardness of rubber, elastomers, and other rubber-like substances. In one embodiment the preferred elastomer used is Silicone which has a hardness of approximately 50 shore.

The elastomer material 220 can be bonded to the substrate 210 by a variety of methods known in the art such as using an adhesive between the elastomer material 220 and substrate 210 or by casting the elastomer material 220 on the substrate 210. Adhesives, which can be used to bond the elastomer material 220 to the substrate 210, include Scotch Grip 1099, Scotch Grip 1357, Weldwood, etc. One skilled in the art will recognize that there are many adhesives which could be used for this purpose and this invention is not limited to the use of any one adhesive.

Although adhesives can be used to bond the elastomer material 220 onto the substrate 210, the preferred method of bonding the elastomer material 220 onto the substrate 210 is by casting the elastomer material 220 onto the substrate 210. The casting process involves filling a mold, which fits over the substrate 210, with granulars of the elastomer material 220 and heating it up until it melts, forming a layer of the elastomer material 220 on the substrate 210. The melting process causes the elastomer material 220 to adhere to the substrate 210 creating a bond between the substrate 210 and the elastomer material 220 when the elastomer material 220 cools and solidifies. Once the elastomer material 220 has solidified, the mold is removed and the elastomer material 220 is grinded down so that it is substantially uniformly thick throughout and its thickness is optimized for a specific application. The optimal thickness of the elastomer material 220 varies from application to application and from material to material. In one embodiment used for contact magnetic printing the optimized thickness of the elastomer material 220 is between 0.1 mm and 4 mm. In many applications the thickness range is even narrower and falls between 0.2 mm and 2 mm. In one embodiment used for contact magnetic printing the thickness of the elastomer material 220 is about 1 mm.

FIG. 3 is an illustration showing an exploded view of a GRAS elastomer pad 200 in a stamping environment wherein an external force is applied to a stamper 150 and magnetic media 155 indirectly through a first magnetic pole 130 a second magnetic pole 135 and a GRAS elastomer pad 200 in accordance with one embodiment of the invention. Unlike the prior art elastomer pad discussed with reference to FIGS. 1C-1E, the GRAS elastomer pad 200 can serve as a backing layer to compensate for the unflatness of the substrate 155 or the stamper 150 without causing the pressure reduction near the outside diameter (OD) edge. Preferably the GRAS elastomer pad 200 is substantially the same size as the substrate 155 so that the pressure applied outside the disk substrate 155 area is substantially reduced or eliminated. By substantially reducing or eliminating the pressure applied outside the magnetic media 155, the chances of bending the stamper 150 during the stamping process, as illustrated in FIG. 1D, is substantially eliminated or reduced. Additionally, since the elastomer material 220 is firmly bonded to the substrate 210 in the GRAS elastomer pad 200, the elastomer does not freely get squeezed out at the outside diameter edge, as illustrated in FIG. 1E, preventing pressure reduction.

FIG. 4A and FIG. 4B show profiles of the pressure on the stamper 150 and magnetic media 155 during the stamping process using the prior art elastomer pad 145 and the GRAS elastomer pad 200 respectively. Additionally, FIG. 4A and FIG. 4B are positioned side-by-side so that the pressure profiles when using the prior art elastomer pad 145 and the GRAS elastomer pad 200 can be compared. The pressure profile diagrams show the intensity of the pressure on the stamper 150 and magnetic media 155 according to the darkness. Darker regions indicate higher pressure then lighter regions.

FIG. 4A shows that when using the prior art elastomer pad 145, the pressure on the stamper 150 and magnetic media 155 is high in most of the center region but is very low in circular bands around both the inside diameter and the outside diameter of the stamper 150 and magnetic media 155. Pressure reduction near the outside diameter edge is due to either the stamper bending or the elastomer being squeezed out by the application of an external force in the stamping process. The pressure reduction near the inside diameter edge is due to the same reasons why the pressure profile is reduced at the outside diameter.

FIG. 4B, on the other hand, shows that when using the GRAS elastomer pad 200, the pressure on the stamper 150 and magnetic media 155 is uniformly high throughout the entire surfaces of the stamper 150 and magnetic media 155, except in a very narrow band near the outside diameter of the stamper 150 and magnetic media 155 and even a smaller band near the inside diameter of the stamper 150 and magnetic media 155. The improvement in the pressure profile between FIG. 4B and FIG. 4A is caused by using the GRAS elastomer pad 200 instead of the conventional elastomer pad 145 in the stamping process. The close fit in size of the GRAS elastomer pad 200 to the stamper 150 and magnetic media 155 reduces the bending of the stamper and the bonding of the elastic material 220 to the substrate 210 prevents elastomer from squeezing out when a force is applied. Each of these effects contribute to the improved pressure profile.

FIG. 5 is a graph showing replicated feature height with imprint lithography, when using a GRAS elastomer pad, as function of magnetic media 155 radius. The magnetic media 155 used to acquire this data is a 95 mm disc so that the outside diameter edge of the disc substrate 155 is located at a radius of 47.5 mm. The data shows that for SYNC the height of the features is very uniform. For SYNC the height of the features is slightly below 200 nm at a 30 mm radius and slightly above 200 nm for data taken at magnetic media radii of 32, 35, 40, 45.5, and 46 mm. Similarly, for PES the height of the features is about 180 nm at a 30 mm radius and increases asymptotically until the height of the features is slightly above 200 nm for data taken at magnetic media radii of 40, 45.5, and 46 mm.

FIG. 6 is a graph showing the signal to noise ratio (SNR) as a function of radius for a magnetic media made using the GRAS elastomer pad in a contact magnetic printing process to write the servo fields. The magnetic media 155 used to acquire this data has a 65 mm radius so that the outside diameter edge of the magnetic media 155 is located at a radius of 32.5 mm or 1.28 inch. The data shows that for three magnetic media samples that were stamped with a press exerting 100 psi, 200 psi and 420 psi the signal to noise ratio remains constant around 22-23 for measurements done at a radius ranging from 1.10 inch to 1.23 inch.

It will also be recognized by those skilled in the art that, while the invention has been described above in terms of preferred embodiments, it is not limited thereto. Various features and aspects of the above-described invention may be used individually or jointly. Further, although the invention has been described in the context of its implementation in a particular environment and for particular applications, those skilled in the art will recognize that its usefulness is not limited thereto and that the present invention can be utilized in any number of environments and implementations.

1. A system for uniformly applying a force to an unflat surface, comprising:
a substrate made of a sturdy material; and
an elastomer material bonded to the substrate.

2. The system of claim 1 wherein said substrate is substantially the same size and shape as the unflat surface.

3. The system of claim 2 wherein said unflat surface is disc shaped.

4. The system of claim 10 wherein said substrate is disc shaped and has an inside diameter and an outside diameter.

5. The system of claim 1 wherein said substrate is the same type of substrate having the unflat surface.

6. The system of claim 1 wherein said elastomer material is selected from the group consisting of Nitrile, Carboxylated Nitrile, Polyacrylate, Ethylene Propylene, Neoprene, Silicone, Vamac, Hydrogenated Nitrile, and Viton.

7. The system of claim 1 wherein said elastomer material is bonded to said substrate by heating said elastomer material on said substrate.

8. The system of claim 1 wherein said elastomer material has a Durometer Shore hardness of 30 to 70 shore.

9. The system of claim 1 wherein said elastomer material has a Durometer Shore hardness of about 50 shore.

10. A system for creating magnetic patterns on a magnetic media, comprising:
a substrate substantially the same shape and size as said magnetic media;
an elastomer material bonded to the substrate, said substrate providing support for said elastomer material.

11. The system of claim 10 wherein said substrate is the same kind of substrate as used for said magnetic media.

12. The system of claim 10 wherein said substrate is disc shaped.

13. The system of claim 10 wherein said substrate is disc shaped and has an inside diameter and an outside diameter.

14. The system of claim 10 wherein said elastomer material is bonded to said substrate by heating said elastomer material on said substrate.

15. The system of claim 10 wherein said elastomer material is silicone.

16. The system of claim 10 wherein said elastomer material has a Durometer Shore hardness of 30 to 70 shore.

17. The system of claim 10 wherein said elastomer material has a Durometer Shore hardness of about 50 shore.

18. A system for creating magnetic patterns on magnetic media, comprising:
a stamper having a pattern;
a press for supplying a force to said stamper and said magnetic media;
an elastomer pad positioned between the stamper and the press for enabling the stamper to conform to the contours of the unflat stamper; and
a magnet for supplying a magnetic field to said stamper and said magnetic media causing said pattern on said stamper to be transferred to said magnetic media.

19. A system for creating magnetic patterns on a magnetic media, comprising:
a means for uniformly distributing an applied force to an unflat magnetic media.

20. The system of claim 19 wherein said means for uniformly distributing an applied force further includes an elastomer material.
